(19) United States
(12) Patent Application Publication
(10) Pub. No.: US 2025/0321019 A1
(43) Pub. Date: Oct. 16, 2025

(54) AIR CONDITIONER AND CONTROL METHOD THEREOF

(71) Applicant: Samsung Electronics Co., Ltd., Suwon-si (KR)

(72) Inventors: Daechul HAN, Suwon-si (KR); Manki HA, Suwon-si (KR); Youngjin KIM, Suwon-si (KR); Sukho LEE, Suwon-si (KR); Sungjin LIM, Suwon-si (KR); Ilyong CHO, Suwon-si (KR); Hyeongkyu CHO, Suwon-si (KR); Kwangsik HAN, Suwon-si (KR); Jun HWANG, Suwon-si (KR)

(21) Appl. No.: 19/251,150

(22) Filed: Jun. 26, 2025

Related U.S. Application Data
(63) Continuation of application No. PCT/KR2023/019418, filed on Nov. 29, 2023.

(30) Foreign Application Priority Data
Jan. 19, 2023 (KR) 10-2023-0008325
Mar. 3, 2023 (KR) 10-2023-0028603

(51) Int. Cl. F24F 11/63

(52) U.S. Cl. CPC F24F 11/63

(57) ABSTRACT

An air conditioner may include: an indoor controller configured to receive an operation command and generate a plurality of first signals corresponding to the operation command; a main controller configured to receive the plurality of first signals, and combine the plurality of first signals to convert the combined first signals into a single second signal; an outdoor unit configured to operate based on the single second signal received from the main controller, and generate a third signal corresponding to an operation state of the outdoor unit; and an indoor unit connected to the main controller and including an indoor fan, wherein the main controller may be configured to control the indoor fan based on the plurality of first signals and the third signal.

### CROSS-REFERENCE TO RELATED APPLICATIONS

This application is a continuation of International Application No. PCT/KR2023/019418 designating the United States, filed on Nov. 29, 2023, in the Korean Intellectual Property Receiving Office and claiming priority to Korean Patent Application Nos. 10-2023-0008325, filed on Jan. 19, 2023, and 10-2023-0028603, filed on Mar. 3, 2023, in the Korean Intellectual Property Office, the disclosures of each of which are incorporated by reference herein in their entireties.

### BACKGROUND

### Field

The disclosure relates to an air conditioner and a method for controlling the same.

### Description of Related Art

Air conditioners may refer to devices for conditioning air in indoor spaces using transfer of heat produced by evaporation and condensation of a refrigerant to cool or heat the air and to discharge the cooled or heated air. The air conditioner may circulate the refrigerant through a compressor, an indoor heat exchanger and an outdoor heat exchanger during cooling or heating operation, and may cool or heat the indoor space by discharging the air that has exchanged heat in the indoor heat exchanger into the indoor space.

An air conditioner may include an indoor controller generating contact signals, and may control cooling and heating based on the contact signals input via the indoor controller. However, existing external input devices such as an indoor controller have limitations in being compatible with outdoor units with improved energy efficiency.

In addition, because an outdoor unit and an indoor unit are connected to an indoor controller through contact points, separate functions of an indoor fan may not be controlled.

### SUMMARY

Embodiments of the disclosure provide an air conditioner and a method for controlling the same that may replace an outdoor unit with an inverter outdoor unit with improved energy efficiency without replacing an indoor controller and an indoor unit, and may control an indoor fan based on a state of the outdoor unit and the indoor unit.

According to an example embodiment of the disclosure, an air conditioner may include: an indoor controller, comprising circuitry, configured to receive an operation command and generate a plurality of first signals corresponding to the operation command; a main controller, comprising circuitry, configured to receive the plurality of first signals by being connected to the indoor controller, and combine the plurality of first signals to convert the combined first signals into a single second signal; an outdoor unit configured to operate based on the single second signal received from the main controller by being connected to the main controller, and generate a third signal corresponding to an operation state of the outdoor unit; and an indoor unit connected to the main controller and including with an indoor fan, wherein the main controller may be configured to control the indoor fan based on the plurality of first signals and the third signal.

According to an example embodiment of the disclosure, a method for controlling an air conditioner may include: receiving, by an indoor controller, an operation command and generating a plurality of first signals corresponding to the operation command; receiving, by a main controller, the plurality of first signals by being connected to the indoor controller, and combining the plurality of first signals to convert the combined first signals into a single second signal; operating, by an outdoor unit, based on the single second signal received from the main controller by being connected to the main controller, and generating a third signal corresponding to an operation state of the outdoor unit; and controlling an indoor fan based on the plurality of first signals and the third signal.

According to the disclosure, an on/off signal of an indoor controller and information of the outdoor unit may be synthesized by implementing communication between an outdoor unit and a main controller, thereby enabling a more stable room temperature control. In addition, when a set target temperature is approached, adjustment of a target pressure and control of an air volume of an indoor unit may be actively performed by the outdoor unit, thereby reducing a frequency of an on/off signal of the indoor controller, minimizing and/or reducing a room temperature variation, and improving energy efficiency.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example configuration of an air conditioner according to various embodiments;

FIG. 2 is a block diagram illustrating an example configuration of an air conditioner according to various embodiments;

FIG. 3 is a diagram illustrating an example main controller according to various embodiments;

FIG. 4 is a diagram illustrating an example connection among a main controller and components of an air conditioner according to various embodiments;

FIG. 5 is a timing diagram illustrating an example process of controlling a defrosting operation by a main controller according to various embodiments;

FIG. 6 is a timing diagram illustrating an example process of controlling a cold air prevention function by a main controller according to various embodiments;

FIG. 7 is a timing diagram illustrating an example process in which an air volume is controlled at light wind by a main controller according to various embodiments;

FIG. 8 is a diagram illustrating an example process in which a light wind signal is output from an outdoor unit in an air conditioner according to various embodiments;

FIG. 9 is a timing diagram illustrating an example process in which an air volume is controlled at gentle wind by a main controller according to various embodiments;

FIG. 10 is a diagram illustrating an example process in which a gentle wind signal is output from an outdoor unit in an air conditioner according to various embodiments;

FIG. 11 is a flowchart illustrating example operations where a second signal includes a defrosting operation entry signal, in an air conditioner according to various embodiments;

FIG. 12 is a flowchart illustrating example operations where a second signal includes a cold air prevention signal, in an air conditioner according to various embodiments; and

FIG. 13 is a flowchart illustrating example operations where a second signal includes an air volume control signal, in an air conditioner according to various embodiments.

### DETAILED DESCRIPTION

Various embodiments of the disclosure and terms used herein are not intended to limit the technical features described herein to any specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

An air conditioner 1 according to various example embodiments may refer to a device that performs functions such as purification, ventilation, humidity control, cooling or heating in an air conditioning space (hereinafter referred to as “indoor space”), and in particular a device having at least one of these functions.

According to an embodiment, an air conditioner 1 may include a heat pump device to perform a cooling function or a heating function. The heat pump device may include a refrigeration cycle in which a refrigerant is circulated through a compressor, a first heat exchanger, and an expansion device and a second heat exchanger. All of the components of the heat pump device may be embedded in a single housing forming an exterior of an air conditioner 1, which includes a window-type air conditioner or a portable air conditioner. On the other hand, some components of the heat pump device may be divided and embedded in a plurality of housings forming a single air conditioner 1, which includes a wall-mounted air conditioner, a stand-type air conditioner, and a system air conditioner.

The air conditioner 1 including the plurality of housings may include at least one outdoor unit 20 installed outdoors and at least one indoor unit installed indoors. For example, the air conditioner 1 may be provided such that a single outdoor unit 20 and a single indoor unit 30 are connected by a refrigerant pipe. The air conditioner 1 may be provided such that a single outdoor unit 20 is connected to two or more indoor units 30 by a refrigerant pipe. The air conditioner 1 may be provided such that two or more outdoor units 20 and two or more indoor units 30 are connected by a plurality of refrigerant pipes.

The outdoor unit 20 may be electrically connected to the indoor unit 30. For example, information (or commands) for controlling the air conditioner 1 may be received through an input interface provided in the outdoor unit 20 or the indoor unit 30. The outdoor unit 20 and the indoor unit 30 may operate simultaneously or sequentially in response to a user input.

The air conditioner 1 may include an outdoor heat exchanger provided in the outdoor unit 20, an indoor heat exchanger provided in the indoor unit 30, and a refrigerant pipe connecting the outdoor heat exchanger and the indoor heat exchanger.

The outdoor heat exchanger may be configured to exchange heat between a refrigerant and air from outdoor through a phase change of the refrigerant (e.g., evaporation or condensation). For example, while the refrigerant is condensed in the outdoor heat exchanger, the refrigerant may radiate heat to the outdoor air. While the refrigerant flowing in the outdoor heat exchanger evaporates, the refrigerant may absorb heat from the outdoor air.

The indoor unit 30 is installed indoors. For example, according to the arrangement method of the indoor unit 30, the air conditioner may be classified into a ceiling-type indoor unit, a stand-type indoor unit, a wall-type indoor unit, and the like. For example, the ceiling-type indoor unit may be classified into a 4-way type indoor unit, a 1-way type indoor unit, a duct type indoor unit and the like according to a method of discharging air.

The indoor heat exchanger may be configured to exchange heat between a refrigerant and outdoor air through a phase change of the refrigerant (e.g., evaporation or condensation). For example, while the refrigerant evaporates in the indoor unit 30, the refrigerant may absorb heat from the indoor air. The indoor space may be cooled by blowing the indoor air cooled through the cooled indoor heat exchanger. While the refrigerant is condensed in the indoor heat exchanger, the refrigerant may radiate heat to the indoor air. The indoor space may be heated by blowing the indoor air heated through the high-temperature indoor heat exchanger.

For example, the air conditioner 1 may perform a cooling or heating function by a phase change process of a refrigerant circulated between the outdoor heat exchanger and the indoor heat exchanger. To circulate the refrigerant, the air conditioner 1 may include a compressor to compress the refrigerant. The compressor may draw refrigerant gas through an inlet and compress the refrigerant gas. The compressor may discharge high-temperature and high-pressure refrigerant gas through an outlet. The compressor may be disposed inside the outdoor unit 20.

Through the refrigerant pipe, the refrigerant may be circulated sequentially through the compressor, the outdoor heat exchanger, the expansion device, and the indoor heat exchanger or sequentially circulated through the compressor, the indoor heat exchanger, the expansion device, and the outdoor heat exchanger.

For example, in the air conditioner 1, when a single outdoor unit 20 and a single indoor unit 30 are directly connected through a refrigerant pipe, the refrigerant may be circulated between the single outdoor unit 20 and the single indoor unit 30 through the refrigerant pipe.

For example, in the air conditioner 1, when a single outdoor unit 20 is connected to two or more indoor units 30 through a refrigerant pipe, the refrigerant may flow from the single outdoor unit 20 to the plurality of indoor units 30 through branched refrigerant pipes. Refrigerant discharged from the plurality of indoor units 30 may be combined and circulated to the outdoor unit 20. For example, each of the plurality of indoor units 30 may be directly connected in parallel to the single outdoor unit 20 through a separate refrigerant pipe.

Each of the plurality of indoor units 30 may be operated independently according to an operation mode set by a user. In other words, some of the plurality of indoor units 30 may be operated in a cooling mode while others of the plurality of indoor units 30 are operated in a heating mode. At that time, the refrigerant may be selectively introduced into each indoor unit in a high-pressure state or a low-pressure state, discharged, and circulated to the outdoor unit 20 along a circulation path that is designated through a flow path switching valve to be described in greater detail below.

For example, in the air conditioner 1, when two or more outdoor units 20 and two or more indoor units 30 are connected by the plurality of refrigerant pipes, refrigerant discharged from the plurality of outdoor units 20 may be combined and flow through one refrigerant pipe, and then diverged again at a certain point and introduced into the plurality of indoor units 30.

All of the plurality of outdoor units 20 may be driven or at least some of the plurality of outdoor units 20 may not be driven, in accordance with to a driving load corresponding to an operating amount of the plurality of indoor units 30. At that time, the refrigerant may be provided through a flow path switching valve to be introduced into and circulated to an outdoor unit 20 that is selectively driven. The air conditioner may include the expansion device to reduce the pressure of the refrigerant flowing into the heat exchanger. For example, the expansion device may be disposed inside the indoor unit 30 or inside the outdoor unit 20, or disposed both inside the indoor unit 30 and the outdoor unit 20.

The expansion device may reduce the temperature and pressure of the refrigerant using a throttling effect. The expansion device may include an orifice configured to reduce a cross-sectional area of a flow path. A temperature and pressure of the refrigerant passing through the orifice may be lowered.

For example, the expansion device may be implemented as an electronic expansion valve configured to adjust an opening ratio (a ratio of a cross-sectional area of a flow path of a valve in a partially opened state to a cross-sectional area of the flow path of the valve in a fully opened state). According to the opening ratio of the electronic expansion valve, the amount of refrigerant passing through the expansion device may be adjusted.

The air conditioner 1 may further include a flow path switching valve disposed on the refrigerant circulation path. The flow path switching valve may include a 4-way valve. The flow path switching valve may determine a refrigerant circulation path depending on an operation mode of the indoor unit 30 (e.g., cooling operation or heating operation). The flow path switching valve may be connected to the outlet of the compressor.

The air conditioner 1 may include an accumulator. The accumulator may be connected to the inlet of the compressor. A low-temperature and low-pressure refrigerant, which is evaporated in the indoor heat exchanger or the outdoor heat exchanger, may flow into the accumulator.

When a refrigerant mixture of refrigerant liquid and refrigerant gas is introduced, the accumulator may separate the refrigerant liquid from the refrigerant gas, and supply the refrigerant gas separated from the refrigerant liquid to the compressor.

An outdoor fan may be installed near the outdoor heat exchanger. The outdoor fan may blow outdoor air to the outdoor heat exchanger to promote heat exchange between the refrigerant and the outdoor air.

The outdoor unit 20 of the air conditioner 1 may include at least one sensor. For example, the outdoor unit sensor may be provided as an environmental sensor. The outdoor unit sensor may be disposed at a given position of the inside or the outside of the outdoor unit 20. For example, the outdoor unit sensor may include a temperature sensor configured to detect an air temperature around the outdoor unit 20, an air humidity sensor configured to detect air humidity around the outdoor unit 20, or a refrigerant temperature sensor configured to detect a refrigerant temperature in a refrigerant pipe passing through the outdoor unit 20, or a refrigerant pressure sensor configured to detect a refrigerant pressure in a refrigerant pipe passing through the outdoor unit 20.

The outdoor unit 20 of the air conditioner 1 may include an outdoor unit communication circuitry 100. The outdoor unit communication circuitry 100 may be configured to receive a control signal from an indoor unit controller 110 of the air conditioner 1, which will be described in greater detail below. Based on a control signal received through the outdoor unit communication circuitry 100, the outdoor unit 20 may control the operation of the compressor, the outdoor heat exchanger, the expansion device, the flow path switching valve, the accumulator, or the outdoor fan. The outdoor unit 20 may transmit a measurement value detected by the outdoor unit sensor to the indoor unit controller 110 through the outdoor unit communication circuitry 100.

The indoor unit 30 of the air conditioner 1 may include a housing, a blower configured to circulate air inside or outside the housing, and the indoor heat exchanger configured to exchange heat with air introduced into the housing.

The housing may include an inlet. Indoor air may flow into the housing through the inlet.

The indoor unit 30 of the air conditioner 1 may include a filter configured to filter out foreign substance in air that is introduced into the inside of the housing through the inlet.

The housing may include an outlet. Air flowing inside the housing may be discharged to the outside of the housing through the outlet.

An airflow guide configured to guide a direction of air discharged through the outlet may be provided in the housing of the indoor unit 30. For example, the airflow guide may include a blade positioned in the outlet. For example, the airflow guide may include an auxiliary fan for regulating an exhaust airflow, but is not limited thereto. The airflow guide may be omitted.

The indoor heat exchanger and the blower arranged on a flow path connecting the inlet and the outlet may be disposed inside the housing of the indoor unit 30.

The blower may include an indoor fan and a fan motor. For example, the indoor fan may include an axial fan, a mixed-flow fan, a cross-flow fan and a centrifugal fan.

The indoor heat exchanger may be arranged between the blower and the outlet or between the inlet and the blower. The indoor heat exchanger may absorb heat from air introduced through the inlet or transfer heat to air introduced through the inlet. The indoor heat exchanger may include a heat exchange tube through which refrigerant flows, and heat exchange fins in contact with the heat exchange tube to increase a heat transfer area.

The indoor unit 30 of the air conditioner 1 may include a drain tray disposed below the indoor heat exchanger to collect condensed water generated in the indoor heat exchanger. The condensed water contained in the drain tray may be drained to the outside through a drain hose. The drain tray may be arranged to support the indoor heat exchanger.

The indoor unit 30 of the air conditioner 1 may include an input interface. The input interface may include any type of user input means including a button, a switch, a touch screen and/or a touch pad. A user can directly input setting data (e.g., desired indoor temperature, cooling/heating/dehumidifying/air cleaning operation mode setting, outlet selection setting, and/or air volume setting) through the input interface.

The input interface may be connected to an external input device. For example, the input interface may be electrically connected to a wired remote controller. The wired remote controller may be installed at a specific location (e.g., a part of a wall) in an indoor space. A user may input setting data related to the operation of the air conditioner by manipulating the wired remote controller. An electrical signal corresponding to the setting data obtained by the wired remote controller may be transmitted to the input interface. In addition, the input interface may include an infrared sensor. A user may remotely input the setting data for operating the air conditioner using a wireless remote controller. The setting data received by the wireless remote controller may be transmitted to the input interface as an infrared signal.

In addition, the input interface may include a microphone. A user's voice command may be obtained through the microphone. The microphone may convert a user's voice command into an electrical signal and transmit the converted electrical signal to the indoor unit controller 110. The indoor unit controller 110 may control components of the air conditioner to perform a function corresponding to the user's voice command. The setting data obtained through the input interface (e.g., desired indoor temperature, cooling/heating/dehumidifying/air cleaning operation mode setting, outlet selection setting, and/or air volume setting) may be transmitted to the indoor unit controller 110 to be described in greater detail below. For example, the setting data obtained through the input interface may be transmitted to the outside, that is, to the outdoor unit 20 or a server through an indoor unit communication circuitry 100 to be described in greater detail below.

The indoor unit 30 of the air conditioner 1 may include a power module. The power module may be connected to an external power source to supply power to components of the indoor unit 30.

The indoor unit 30 of the air conditioner 1 may include an indoor unit sensor. The indoor unit sensor may be an environmental sensor disposed inside or outside the housing. For example, the indoor unit sensor may include one or more temperature sensors and/or humidity sensors disposed in a predetermined space inside or outside the housing of the indoor unit 30. For example, the indoor unit sensor may include a refrigerant temperature sensor configured to detect a refrigerant temperature of a refrigerant pipe passing through the indoor unit 30. For example, the indoor unit sensor may include a refrigerant temperature sensor each configured to detect a temperature of an entrance, a middle portion and/or an exit of the refrigerant pipe passing through the indoor heat exchanger.

For example, each environmental information detected by the indoor unit sensor may be transmitted to the indoor unit controller 110 to be described in greater detail below or transmitted to the outside through the indoor unit communication circuitry 100 to be described in greater detail below.

The indoor unit 30 of the air conditioner 1 may include the indoor unit communication circuitry 100. The indoor unit communication circuitry 100 may include at least one of a short-range wireless communication module and a long-range wireless communication module. The indoor unit communication circuitry 100 may include at least one antenna for wirelessly communicating with other devices. The outdoor unit 20 may include the outdoor unit communication circuitry 100. The outdoor unit communication circuitry 100 may also include at least one of a short-range wireless communication module and a long-range wireless communication module.

The short-range wireless communication module may include a Bluetooth communication module, a Bluetooth Low Energy (BLE) communication module, a near field communication module, a WLAN (Wi-Fi) communication module, and a Zigbee communication module, an infrared data association (IrDA) communication module, a Wi-Fi Direct (WFD) communication module, an ultrawideband (UWB) communication module, an Ant+ communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, and a server in a mobile communication network.

The indoor unit communication circuitry 100 may communicate with an external device such as a server, a mobile device and other home appliances through an access point (AP). The AP may connect a local area network (LAN), to which an air conditioner or a user device is connected, to a wide area network (WAN) to which a server is connected. The air conditioner or the user device may be connected to the server through the WAN. The indoor unit 30 of the air conditioner may include the indoor unit controller 110 configured to control components of the indoor unit including the blower. The outdoor unit 20 of the air conditioner may include an outdoor unit controller 110 configured to control components of the outdoor unit including the compressor. The indoor unit controller 110 may communicate with the outdoor unit controller 110 through the indoor unit communication circuitry 100 and the outdoor unit communication circuitry 100. The outdoor unit communication circuitry 100 may transmit a control signal generated by the outdoor unit controller 110 to the indoor unit communication circuitry 100, or transmit a control signal, which is transmitted from the indoor unit communication circuitry 100, to the outdoor unit controller 110. For example, the outdoor unit 20 and the indoor unit 30 may perform bi-directional communication. The outdoor unit 20 and the indoor unit 30 may transmit and receive various signals generated during the operation of the air conditioner.

The outdoor unit controller 110 may be electrically connected to components of the outdoor unit 20 and may control the operation of each component. For example, the outdoor unit controller 110 may adjust a frequency of the compressor and control the flow path switching valve to change a circulation direction of the refrigerant. The outdoor unit controller 110 may adjust a rotational speed of the outdoor fan. The outdoor unit controller 110 may generate a control signal to adjust the opening degree of the expansion valve. Under the control of the outdoor unit controller 110, the refrigerant may be circulated along the refrigerant circulation circuit including the compressor, the flow path switching valve, the outdoor heat exchanger, the expansion valve, and the indoor heat exchanger.

Various temperature sensors included in the outdoor unit 20 and the indoor unit 30 may transmit electrical signals corresponding to detected temperatures to the outdoor unit controller 110 and/or the indoor unit controller 110. For example, the humidity sensors included in the outdoor unit 20 and the indoor unit 30 may respectively transmit electrical signals corresponding to the detected humidity to the outdoor unit controller 110 and/or the indoor unit controller 110.

The indoor unit controller 110 may obtain an input (e.g., a user input) from a user device including a mobile device through the indoor unit communication circuitry 100, or directly obtain a user input through the input interface or the remote controller. The indoor unit controller 110 may control components of the indoor unit including the blower in response to the received user input. The indoor unit controller 110 may transmit information related to the received user input to the outdoor unit controller 110 of the outdoor unit 20.

The outdoor unit controller 110 may control components of the outdoor unit including the compressor based on the information related to the user input received from the indoor unit 30. For example, when a control signal corresponding to a user input for selecting an operation mode such as a cooling operation, a heating operation, a fan operation, a defrosting operation, or a dehumidifying operation is received from the indoor unit 30, the outdoor unit controller 110 may control components of the outdoor unit 20 to perform an operation of the air conditioner corresponding to the selected operation mode.

The outdoor unit controller 110 and the indoor unit controller 110 may include a processor 111 and a memory 112, respectively. The indoor unit controller 110 may include at least one a first processor 111 and at least one a first memory 112, and the outdoor unit controller 110 may include at least one a second processor 111 and at least one a second memory 112.

The memory 112 may record/store various types of information necessary for the operation of the air conditioner. The memory 112 may store instructions, applications, data and/or programs necessary for the operation of the air conditioner. For example, the memory 112 may store various programs for the cooling operation, the heating operation, the dehumidifying operation, and/or the defrosting operation of the air conditioner. The memory may include volatile memory, such as a static random access memory (S-RAM) and a dynamic random access memory (D-RAM) for temporarily storing data. In addition, the memory may include a non-volatile memory, such as a read only memory (ROM), an erasable programmable read only memory (EPROM), and an electrically erasable programmable read only memory (EEPROM) for long-term storage of data.

The processor 111 may generate a control signal for controlling an operation of the air conditioner based on instructions, applications, data, and/or programs stored in the memory. The processor 111 may be hardware and may include a logic circuit and an arithmetic circuit. The processor 111 may process data according to a program and/or instructions provided from the memory 112, and may generate a control signal according to a processing result. The memory 112 and the processor 111 may be implemented as one control circuit or as a plurality of circuits.

The indoor unit 30 of the air conditioner 1 may include an output interface. The output interface may be electrically connected to the indoor unit controller 110, and output information related to the operation of the air conditioner under the control of the indoor unit controller 110. For example, the output interface may output information, such as an operation mode selected by an input (e.g., a user input), a wind direction, a wind volume, and a temperature. In addition, the output interface may output sensing information obtained from the indoor unit sensor or the outdoor unit sensor, and output warning/error messages.

The output interface may include a display and a speaker. The speaker may be a sound device and configured to output various sounds. The display may display information, which is input by a user or provided to a user, as various graphic elements. For example, operational information of the air conditioner may be displayed as at least one of an image and text. In addition, the display may include an indicator that provides specific information. The display may include a liquid crystal display (LCD) panel, a light emitting diode (LED) panel, an organic light emitting diode (OLED) panel, a micro-LED panel, and/or a plurality of LEDs.

Hereinafter, various example embodiments of the disclosure will be described in greater detail with reference to the accompanying drawings.

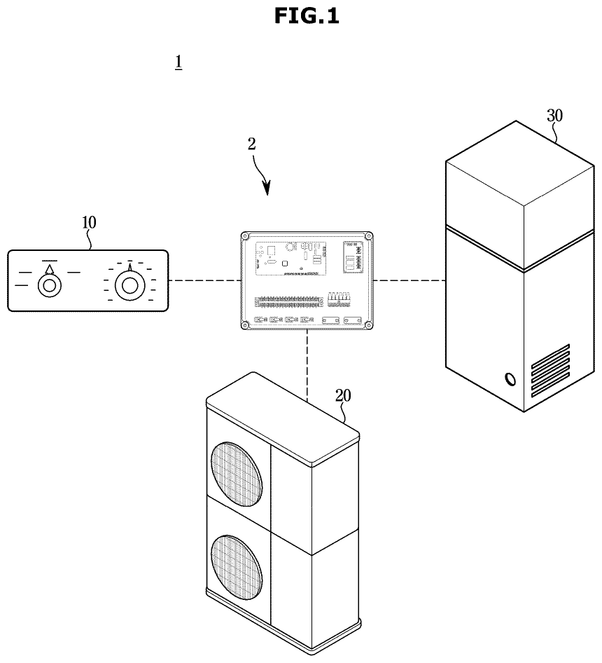

FIG. 1 is a diagram illustrating an example configuration of an air conditioner according to various embodiments.

Referring to FIG. 1, an air conditioner 1 includes an outdoor unit 20 disposed in an outdoor space for performing heat exchange between outdoor air and a refrigerant, and an indoor unit 30 disposed in an indoor space for performing heat exchange between indoor air and a refrigerant. The outdoor unit 20 may be located outside an air conditioning space, and the indoor unit 30 may be located in the air conditioning space. The air conditioning space refers to a space that is cooled or heated by the air conditioner 1. For example, the outdoor unit 20 may be placed outside a building, and the indoor unit 30 may be placed in a space separated from the outside by a wall, such as a living room or an office room.

As described above, the outdoor unit 20 and the indoor unit 30 may be connected by an external pipe. A refrigerant may be circulated through the outdoor unit 20, the external pipe, and the indoor unit 30. One end of the external pipe may be connected to a piping valve located on one side of the outdoor unit 20. The external pipe may be connected to a refrigerant pipe provided inside the outdoor unit 20 and the indoor unit 30.

The refrigerant may be circulated to the indoor unit 30 and the outdoor unit 20 along a refrigerant flow path and absorb or emit heat through a phase change (e.g., changing a state from gas to liquid or liquid to gas). The air conditioner 1 may include a liquid pipe connecting the indoor unit 30 and the outdoor unit 20 and serving as a passage in which a liquid refrigerant flows, and a gas pipe serving as a passage in which a gaseous refrigerant flows. The liquid pipe and the gas pipe may extend to the inside the outdoor unit 20 and the indoor unit 30.

The outdoor unit 20 may include a compressor configured to compress the refrigerant, an outdoor heat exchanger configured to perform heat exchange between the outdoor air and the refrigerant, a four-way valve configured to guide the refrigerant compressed by the compressor to the outdoor heat exchanger or an indoor heat exchanger based on cooling operation or heating operation, an expansion valve configured to decompress the refrigerant, and an accumulator configured to prevent and/or reduce a liquid refrigerant that has not evaporated from flowing into the compressor.

The compressor may operate with electric energy provided from an external power source. The compressor includes a compressor motor and compresses a gaseous refrigerant of low pressure into high pressure using a rotational force of the compressor motor. An operation frequency of the compressor may be changed to correspond to a capacity required by the indoor unit 30. The compressor may be an inverter air compressor, a positive displacement compressor, or a dynamic compressor, and various types of compressors that may be considered by a designer may be used.

The indoor unit 30 may include an indoor heat exchanger and an indoor fan. The indoor heat exchanger performs heat exchange between indoor air and a refrigerant. The indoor fan may flow indoor air to the indoor heat exchanger. A plurality of indoor fans may be provided. Indoor heat exchanger temperature sensors may be provided at both sides (inlet and outlet) of the indoor heat exchanger to detect the temperature of the indoor heat exchanger. The indoor heat exchanger temperature sensor may be installed around the inlet and/or outlet of the indoor heat exchanger, or may be installed to contact a refrigerant pipe connected to the inlet and/or outlet of the indoor heat exchanger. An indoor temperature sensor for detecting the indoor temperature may be provided inside the indoor unit 30. The temperature sensor may be implemented with at least one of a bimetal thermometer, a thermistor thermometer, or an infrared thermometer. In addition to the above, the air conditioner 1 may include various types of temperature sensors.

During a cooling operation, the refrigerant may emit heat in the outdoor heat exchanger of the outdoor unit 20 and absorb heat in the indoor heat exchanger of the indoor unit 30. During the cooling operation, the refrigerant compressed by the compressor of the outdoor unit 20 may first be supplied to the outdoor heat exchanger through the four-way valve, and then may be supplied to the indoor heat exchanger of the indoor unit 30 through the expansion valve. During the cooling operation, the outdoor heat exchanger operates as a condenser condensing the refrigerant, and the indoor heat exchanger operates as an evaporator evaporating the refrigerant. During the cooling operation, the high-temperature and high-pressure gaseous refrigerant discharged from the compressor moves to the outdoor heat exchanger. The liquid or approximately liquid-state refrigerant condensed in the outdoor heat exchanger is expanded and decompressed in the expansion valve. The two-phase refrigerant passing through the expansion valve moves to the indoor heat exchanger. The refrigerant introduced into the indoor heat exchanger exchanges heat with ambient air and evaporates. As a result, a temperature of the heat-exchanged ambient air is lowered and cold air is discharged to the outside of the indoor unit 30.

During a heating operation, the refrigerant may emit heat in the indoor heat exchanger and absorb heat in the outdoor heat exchanger. For example, during the heating operation, the refrigerant compressed by the compressor may first be supplied to the indoor heat exchanger through the four-way valve, and then may be supplied to the outdoor heat exchanger. In this case, the indoor heat exchanger operates as a condenser condensing the refrigerant, and the outdoor heat exchanger operates as an evaporator evaporating the refrigerant. During the heating operation, the high-temperature and high-pressure gaseous refrigerant discharged from the compressor moves to the indoor heat exchanger. The high-temperature and high-pressure gaseous refrigerant passing through the indoor heat exchanger exchanges heat with low-temperature dry air. The refrigerant is condensed into a liquid or approximately liquid-state refrigerant to emit heat, and as the air absorbs the heat, heated air is discharged to the outside of the indoor unit 30.

Although it has been described that the air conditioner 1 includes a single outdoor unit 20 and a single indoor unit 30, the air conditioner 1 may include a plurality of outdoor units 20 and a plurality of indoor units 30. For example, a plurality of indoor units 30 may be connected to the single outdoor unit 20. Further, a shape of the indoor unit 30 is not limited to that described above. Any type of indoor unit 30 may be used as long as the indoor unit 30 is installed in an indoor space and is capable of cooling or heating the indoor space.

In addition, the air conditioner 1 may include an indoor controller 10 and a main controller (e.g., including various circuitry) 2. The main controller 2 may be electrically connected to the outdoor unit 20, the indoor unit 30 and the indoor controller 10. The outdoor unit 20, the indoor unit 30, and the indoor controller 10 may be connected to the main controller 2 by wire. The indoor controller 10 may also be referred to as a ‘contact controller’.

The indoor controller 10 may obtain an input (e.g., a user input). The indoor controller 10 may obtain a user input related to an indoor temperature setting or heating/cooling. The main controller 2 may receive a plurality of first signals corresponding to the user input from the indoor controller 10.

The main controller 2 may control operations of the outdoor unit 20 and the indoor unit 30. The main controller 2 may operate the outdoor unit 20 and the indoor unit 30 in response to a user input which is input through the indoor controller 10. The main controller 2 may control an operation of the air conditioner 1 based on a received electrical signal.

The main controller 2 may serve as an adapter connecting various types of outdoor units 20 to the air conditioner 1. The main controller 2 may be provided to control the outdoor unit 20 manufactured by the same manufacturer as the manufacturer of the outdoor unit 20, as well as the outdoor unit 20 manufactured by a different manufacturer, and/or the outdoor unit 20 having a different communication protocol.

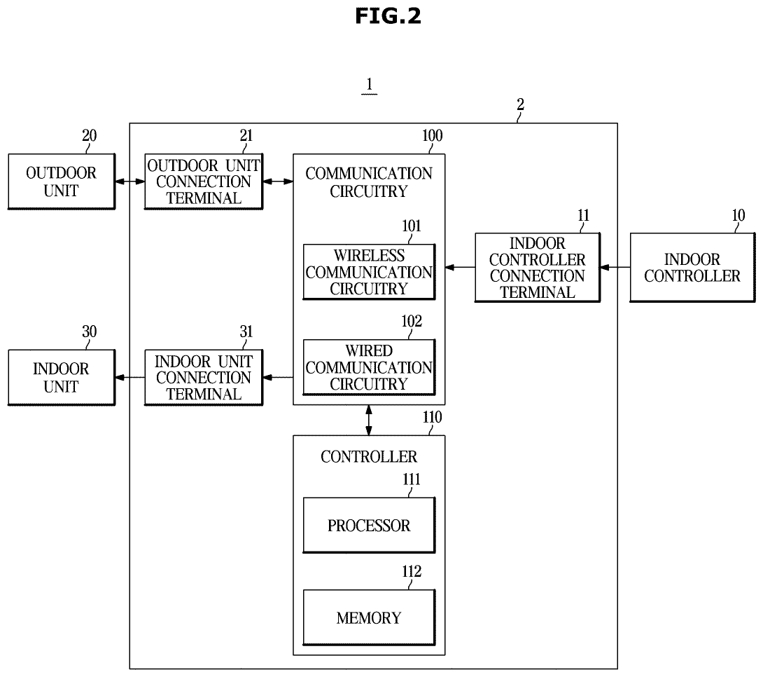

FIG. 2 is a block diagram illustrating an example configuration of an air conditioner according to various embodiments.

Referring to FIG. 2, the air conditioner 1 may include the main controller (e.g., including various circuitry) 2, the outdoor unit 20, the indoor unit 30, the indoor controller (e.g., including circuitry) 10, and the main controller 2 may include a controller (e.g., including circuitry) 110 including a memory 112 and a processor (e.g., including processing circuitry) 111, and communication circuitry 100.

The memory 112 of the main controller 2 may record/store various information required for operating the air conditioner 1. The memory 112 may store instructions, applications, data and programs for operating the air conditioner 1. As described above, the memory 112 may include a volatile memory, such as static random access memory (SRAM) or dynamic random access memory (DRAM) for temporary data storage, and a non-volatile memory, such as read only memory (ROM), erasable programmable read only memory (EPROM), and electrically erasable programmable read only memory (EEPROM) for long-term data storage.

The processor 111 of the main controller 2 may generate a control signal for controlling an operation of the air conditioner 1 based on the instructions, applications, data and programs stored in the memory 112. The processor 111 is a hardware and may include a logic circuit and arithmetic circuit. The processor 111 may process data according to the programs and/or instructions provided from the memory 112, and generate a control signal according to a result of the processing. The memory 112 and the processor 111 may be implemented as one control circuit or as a plurality of circuits.

The main controller 2 may receive the plurality of first signals, transmitted from the indoor controller 10, and determine an operation of the outdoor unit 20 and/or the indoor unit 30. The first signal may include a contact signal generated from the contact controller, and the contact signal refers to a signal that indicates whether a contact formed by a switch is open or closed.

The controller 110 of the main controller 2 may include a signal converter configured to combine the plurality of received first signals to convert the plurality of received first signals into a single second signal. In this instance, the controller 110 may combine signals in an ON state from among the plurality of first signals to convert into the second signal.

The second signal may include a recommended standard (RS) 485 signal corresponding to the RS 485 communication standard, and may also include a communication signal conforming to a communication standard different from the first signal.

The controller 110 may transmit the second signal to the outdoor unit 20 and determine an operation of the outdoor unit 20, and the outdoor unit 20 may operate based on the second signal. Accordingly, the air conditioner 1 according to an embodiment may ensure compatibility even in a case where a previously used outdoor unit 20 is replaced with a different type of outdoor unit 20.

The controller 110 may perform bidirectional communication with the outdoor unit 20 through an outdoor unit connection terminal 21 including a transmitting terminal and a receiving terminal. For example, the controller 110 may control the communication circuitry 100 to transmit the second signal to the transmitting terminal, and receive an operation signal related to the operation of the outdoor unit 20, e.g., a third signal, from the receiving terminal. Accordingly, the controller 110 may determine a current operating state of the outdoor unit 20 and a control operation required for the outdoor unit 20. For example, the controller 110 may determine whether to enter a defrosting operation, whether to perform a cold air prevention function, and whether to perform an air volume control function based on an operation signal of the outdoor unit 20.

The controller 110 may determine an operation of the indoor unit 30 based on the plurality of first signals, and may control the communication circuitry 100 to transmit the determined operation of the indoor unit 30 to the indoor unit 30. Specifically, the controller 110 may determine an operation mode and a set temperature of the indoor unit 30 corresponding to the plurality of first signals.

The controller 110 may determine an operation of the indoor unit 30 by blocking transmission of at least one first signal among the plurality of first signals for a reference period of time. For example, the controller 110 may block an indoor fan signal from among the plurality of first signals for a predetermined reference period of time, thereby enabling efficient defrosting operation. Accordingly, even in a case where the indoor unit 30 is a different type of indoor unit other than an inverter indoor unit, an air conditioner fan, auxiliary heat source, and other air conditioning devices may be controlled by delaying or blocking a portion of signals.

In this instance, the operation of the indoor unit 30 may include selecting one from a plurality of operation stages, and the plurality of operation stages may include low, medium, and high cooling and heating levels.

In addition, the controller 110 may control the indoor fan based on the plurality of first signals and the third signal corresponding to an operating state of the outdoor unit 20 generated from the outdoor unit 20. In this instance, the third signal may include any one of an air volume control signal, a defrosting operation signal, or a cold air prevention signal.

For example, based on the third signal being the air volume control signal, the controller 110 may determine an air volume control terminal that outputs an indoor fan control signal from among a plurality of air volume control terminals provided in the main controller 2 by combining the number of times an OFF signal is output and an off signal output time of the indoor controller 10. For example, the controller 110 may determine an air volume control terminal to reduce an air volume of the indoor unit 30 based on the number of times an OFF signal is output being greater than a reference number of times and the off signal output time being greater than a reference period of time.

Based on the third signal being the defrosting operation signal, the controller may delay and output the OFF signal of the indoor fan for a reference period of time, and may output an ON signal of the indoor fan the reference period of time earlier than at a time when a defrosting operation termination signal for ending a defrosting operation is received from the outdoor unit 20.

Based on the third signal being the cold air prevention/reduction signal, the controller may delay and output the OFF signal of the indoor fan for a reference period of time, and may delay and output the ON signal of the indoor fan until a pressure of the compressor is greater than or equal to a reference pressure based on receiving a signal to restart the heating operation from the outdoor unit 20.

The communication circuitry 100 of the main controller 2 may include a circuit for electrically connecting the outdoor unit 20, the indoor unit 30, and the indoor controller 10. For example, the communication circuitry 100 may include a plurality of contact terminals connected to the indoor controller 10. The plurality of contact terminals may include the outdoor unit connection terminal 21 and an indoor unit connection terminal 31.

The communication circuitry 100 may include wired communication circuitry 102 and/or wireless communication circuitry 101 to communicate with the outdoor unit 20 and the indoor unit 30. The communication circuitry 100 may transmit a control signal transmitted from the processor 111 to the outdoor unit 20 and the indoor unit 30, or may transmit an electrical signal transmitted from the outdoor unit 20 and the indoor unit 30 to the processor 111.

The communication circuitry 100 may perform communication with an access point (AP, not shown) separately provided in an air conditioning space, and may be connected to a network through the access point. The communication circuitry 100 may communicate with an external device (e.g., a smartphone) through the access point. The communication circuitry 100 may receive information of an external device connected to the access point and transmit the information of the external device to the processor 111. Through the above, a user may remotely control the air conditioner 1.

The air conditioner 1 according to an embodiment may further include a remote controller (not shown). The remote controller may include an input portion and a display. The input portion of the remote controller may obtain a user input and output an electrical signal (voltage or current) corresponding to the user input to the main controller 2. For example, the remote controller may obtain a power ON/OFF input for turning on or off the air conditioner 1, an operation mode selection input for setting an operation mode of the air conditioner 1, and/or a temperature adjustment input for adjusting an indoor temperature.

The input portion of the remote controller may be implemented as a variety of buttons and/or dials. For example, a plurality of buttons may include a push switch operated by a user pressing, a membrane switch, and/or a touch switch operated by contact with a part of user's body. The buttons may include an operation mode button for selecting an operation mode such as a cooling operation, a heating operation and a fan operation, a temperature button for setting a target temperature of an indoor space (air conditioning space), a wind direction button for setting a wind direction, and/or an air volume button for setting a wind level (rotational speed of an indoor fan). The buttons may also be implemented as rotatable dials.

The display of the remote controller may display information about a state and/or operation of the air conditioner 1. The display may display information input by a user or information provided to the user in various screens. The display may display information related to the operation of the air conditioner 1 as at least one of an image or text. In addition, the display may display a graphic user interface (GUI) allowing control of the air conditioner 1. That is, the display may display user interface elements (UI elements) such as icons.

The display of the remote controller may include various types of display panels. For example, the display may include a liquid crystal display (LCD) panel, a light emitting diode (LED) panel, an organic light emitting diode (OLED) panel, or a micro LED panel. The display may be implemented as a touch display. The touch display may include a display panel for displaying an image and a touch panel for receiving a touch input. In a case where the display is provided as a touch display, an input portion may not be separately provided in the remote controller.

The indoor controller 10 may obtain an input (e.g., a user input). For example, the indoor controller 10 may obtain an operation mode selection input for selecting an operation mode and a temperature setting input for setting an indoor temperature. The indoor controller 10 may be a separate input device distinguished from the remote controller. The indoor controller 10 may have a simpler structure than the remote controller. The indoor temperature setting or current setting of the outdoor unit 20 may be simply input by the indoor controller 10.

The indoor controller 10 may include an operation mode input portion and a regulator. The operation mode input portion and the regulator may each be provided as a rotatable dial, without being limited thereto. The operation mode input portion and the regulator may be provided in various shapes. The operation mode input portion and the regulator may include various buttons.

The operation mode input portion may be provided to select an operation mode of the air conditioner 1. The indoor controller 10 may transmit an electrical signal (operation mode selection signal) corresponding to an operation of the operation mode input portion to the main controller 2. For example, the operation mode of the air conditioner 1 may include a cooling operation mode, a heating operation mode, and an automatic operation mode. The air conditioner 1 may operate in the operation mode selected by manipulation of the operation mode input portion. That is, the air conditioner 1 may perform a cooling operation, a heating operation, or an automatic operation. A user may select a power-off, cooling operation, heating operation, or automatic operation by manipulating the operation mode input portion.

Components of the air conditioner 1 are not limited thereto. Other components may be added to the air conditioner 1 in addition to the aforementioned components of the outdoor unit 20.

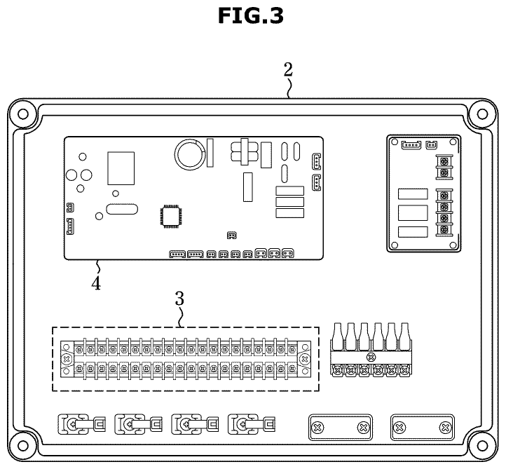

FIG. 3 is a diagram illustrating an example main controller according to various embodiments.

Referring to FIG. 3, the main controller 2 may include a main circuit board 4 and a plurality of contact terminals 3. The memory 112 and the processor 111 may be mounted on the main circuit board 4. The processor 111 may be referred to as ‘Micom’. The communication circuitry 100 may communicate with an external device through terminal blocks for connecting with other devices in addition to the contact terminals 3.

The outdoor unit 20, the indoor unit 30 and the indoor controller 10 may be connected to the plurality of contact terminals 3. The contact terminals 3 include at least one of a F1 terminal, a F2 terminal, a TR terminal, a TEI terminal, a TEO terminal, a F3 terminal, a F4 terminal, a COM terminal, an AUT terminal, a HP terminal, a CO terminal, an AV1 terminal, or an AV2 terminal. The contact terminals 3 and each of the outdoor unit 20, the indoor unit 30, and the indoor controller 10 may be connected with each other by wire and/or cables.

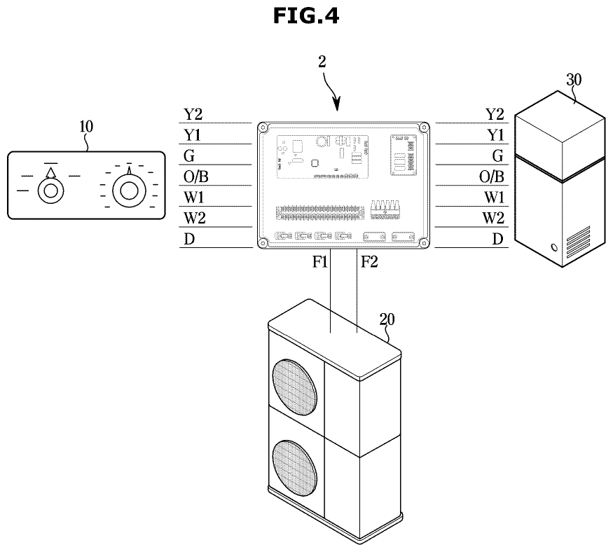

For example, the outdoor unit 20 may be connected to a F1 terminal and a F2 terminal (see, e.g., FIG. 4) from among the contact terminals 3. The main controller 2 may communicate with the outdoor unit 20 through the F1 terminal and the F2 terminal. For example, a signal generated by the processor 111 of the main controller 2 may be transmitted to the outdoor unit 20 through the F1 terminal and F2 terminal, and a signal generated by the outdoor unit 20 may be transmitted to the processor 111 through the F1 terminal and the F2 terminal.

The indoor unit 30 may be connected to a TR terminal, a TEI terminal, and a TEO terminal (not shown) among the contact terminals 3. As described above, the indoor unit 30 may include an indoor temperature sensor and an indoor heat exchanger temperature sensor. A signal generated by the indoor temperature sensor of the indoor unit 30 may be input to the processor 111 of the main controller 2 through the TR terminal. A signal generated by the indoor heat exchanger temperature sensor of the indoor unit 30 may be input to the processor 111 of the main controller 2 through the TEI terminal and the TEO terminal.

The remote controller may be connected to a F3 terminal and a F4 terminal (not shown) from among the contact terminals 3. The main controller 2 may communicate with the remote controller through the F3 terminal and the F4 terminal. For example, a signal generated by the processor 111 of the main controller 2 may be transmitted to the remote controller through the F3 terminal and the F4 terminal, and a signal generated by the remote controller may be transmitted to the processor 111 through the F3 terminal and the F4 terminal.

The indoor controller 10 may be connected to a COM terminal, an AUT terminal, a HP terminal, a CO terminal, an AV1 terminal, and an AV2 terminal (not shown) from among the contact terminals 3. The COM terminal, the AUT terminal, the HP terminal, and the CO terminal may be connected to an operation mode input portion of the indoor controller 10. The COM terminal may refer to a common terminal, an auto operation signal may be input to the AUT terminal, a heating operation signal may be input to the HP terminal, and a cooling operation signal may be input to the CO terminal. A signal may be input to one of the AUT terminal, the HP terminal, or the CO terminal according to an operation of the operation mode input portion.

The AV1 terminal and the AV2 terminal may be connected to the regulator of the indoor controller 10. The AV1 terminal may be referred to as a first contact terminal, and the AV2 terminal may be referred to as a second contact terminal. A voltage of a signal applied to the first contact terminal (AV1 terminal) may vary depending on an operation of the regulator. In other words, the voltage applied between the first contact terminal (AV1 terminal) and the second contact terminal (AV2) may vary depending on the operation of the regulator. The main controller 2 may determine a target temperature of an indoor space or a maximum current applied to the outdoor unit 20 based on the voltage of the signal applied to the first contact terminal (AV1 terminal).

FIG. 4 is a diagram illustrating an example connection among a main controller and components of an air conditioner according to various embodiments.

Referring to FIG. 4, a contact signal line of the indoor controller 10 may be connected to the main controller 2. For example, a first compressor terminal Y1 for controlling the compressor and fan output, a second compressor terminal Y2 for further adjusting the compressor and fan output, a first auxiliary heat source terminal W1 for controlling a first auxiliary heat source, a second auxiliary heat source terminal W2 for controlling a second auxiliary heat source, a fan terminal G for controlling the indoor fan, a four-way valve terminal O/B for controlling a four-way valve, and the like may be connected to the main controller 2, without being directly connected to the indoor unit 30 or the outdoor unit 20.

The main controller 2 may convert a first signal received from the indoor controller 10 to generate a second signal, may transmit the second signal to the outdoor unit 20, and may precisely control an operation of the indoor unit 30 by delaying or blocking the first signal.

In existing technologies, an outdoor unit using a different communication method from the indoor controller 10 could not be installed, but a signal may be converted according to a communication method by the main controller 2 of the air conditioner 1 according to an embodiment. Thus, even in a case where the outdoor unit 20 has a different communication method, the air conditioner 1 according to an embodiment may use the outdoor unit 20 using the different communication method. Further, in existing technologies, an air conditioner fan, auxiliary heat source, and other air conditioning devices could not be precisely controlled by a contact communication method, but the air conditioner fan, auxiliary heat source, and other air conditioning devices may be precisely controlled based on signal blockage or delay of the main controller 2.

For example, the indoor controller 10 and the indoor unit 30 may transmit and receive the first signal by a first communication method of the contact communication method, but may not support a second communication method of the RS 485 communication. The outdoor unit 20 may receive the second signal by the second communication method of the RS 485 communication, but may not support the first communication method of contact-based communication. Supporting a communication method may refer to a connection terminal and a signal processing circuit for communicating by the corresponding communication method being provided, and refer to that transmission and reception of signals may be performed by the corresponding communication method.

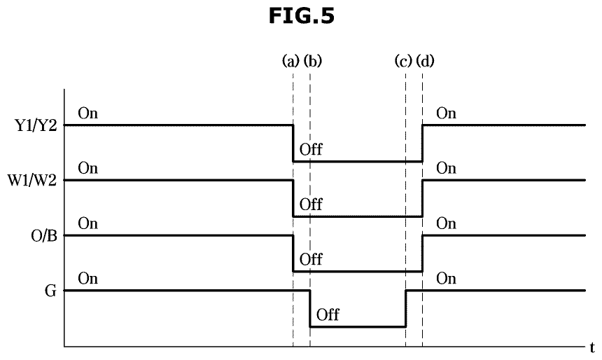

A technical problem that may be addressed by the main controller 2 is described in greater detail below with reference to FIG. 5.

FIG. 5 is a timing diagram illustrating an example process of controlling a defrosting operation by a main controller according to various embodiments.

Referring to FIG. 5, the controller 110 of the main controller 2 may receive a plurality of first signals, which are contact signals, from the indoor controller 10, and may control functions that could not be controlled with contact signals in existing technologies by delaying or blocking a portion of the plurality of first signals.

The controller 110 of the main controller 2 according to an embodiment may receive an outdoor unit defrost signal from the outdoor unit 20 and enter a defrosting operation (a) based on the outdoor unit defrost signal. Upon receiving the outdoor unit defrost signal, the controller 110 may control signals of the first compressor terminal Y1, the second compressor terminal Y2, the first auxiliary heat source terminal W1, the second auxiliary heat source terminal W2, the four-way valve terminal O/B, and the indoor fan terminal G to be in an OFF state.

In this instance, the controller 110 may change (b) the indoor fan terminal G to an OFF state later than the other terminals by a predetermined time, and change (c) the indoor fan terminal G to an ON state earlier than the other terminals by a predetermined (e.g., specified) time.

The defrosting operation is for removing frost caused by a drop in temperature around the outdoor unit 20, and corresponds to a process of melting the frost on a surface of the outdoor unit 20 according to a cooling operation principle. Accordingly, in response to entering the defrosting operation during the heating operation, the controller 110 may stop the air conditioner 1 and other devices during the defrosting operation by blocking the contact signals output from the main controller to the air conditioner 1 in order to prevent and/or reduce cold air from releasing to the indoor space during frosting, and may remove residual heat inside the air conditioner 1 by delaying the switching of the indoor fan signal G to an OFF state than other signals. Thereafter, when the defrosting operation is finished (c), the controller 110 may delay and output other signals after outputting the indoor fan signal G, thereby preventing/reducing overheating during an operation of a heat exchanger and a heater. In this instance, a reference period of time at which the controller 110 delays and outputs or early outputs the indoor fan signal G may be predetermined by a designer of the air conditioner 1 or may be set by a user.

As described above, the air conditioner 1 according to an embodiment of the disclosure may provide a function of the indoor unit 30 that could not be provided by an existing contact-type air conditioner, thereby improving user convenience.

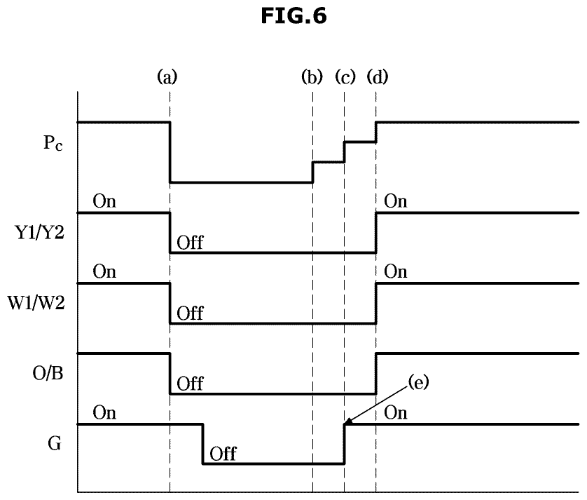

FIG. 6 is a timing diagram illustrating an example process of controlling a cold air prevention function by a main controller according to various embodiments.

Referring to FIG. 6, the controller 110 may delay or block a plurality of first signals received from the indoor controller 10 to provide a cold air prevention function.

When a user turns on the air conditioner 1 and operates a heating operation, a frequency of the compressor is gradually increased, and thus cold air may be introduced into an indoor space at the beginning of operation. Accordingly, the controller 110 may control a signal of the indoor fan terminal G to be an OFF state until a pressure of the compressor reaches a target pressure, thereby preventing/reducing cold air from entering the indoor space at the beginning of the heating operation.

For example, in a case where a situation occurs in which heating should be stopped (a), such as when a defrosting operation signal is received, the controller 110 may control signals of the first compressor terminal Y1, the second compressor terminal Y2, the first auxiliary heat source terminal W1, the second auxiliary heat source terminal W2, the four-way valve terminal O/B, and the indoor fan terminal G to be in an OFF state. In this instance, as described in FIG. 5, the controller may delay the signal of the indoor fan terminal G for a predetermined reference period of time to remove the residual heat inside the air conditioner, and then output an OFF signal.

In existing technologies, an indoor fan output signal is controlled to change to an ON state, immediately after a situation that requires restart of the heating (b) occurs.

However, in the disclosure, in a case where a situation that requires restart of the heating (b) occurs, the controller 110 may control the signal of the indoor fan terminal G to an OFF state until a pressure Pc of the compressor reaches a predetermined design pressure, and based on the pressure Pc of the compressor reaching the predetermined design pressure, the controller 110 may control (e) the signal of the indoor fan terminal G to an ON state. Accordingly, no wind may be introduced into the indoor space until the pressure of the compressor reaches the design pressure, thereby preventing/reducing cold air from entering the indoor space during heating.

The controller 110 may control the signals of the first compressor terminal Y1, the second compressor terminal Y2, the first auxiliary heat source terminal W1, the second auxiliary heat source terminal W2, and the four-way valve terminal O/B to an ON state by placing an additional delay time (d) after the indoor fan starts operating, and may thus operate the auxiliary heat source with sufficient air volume.

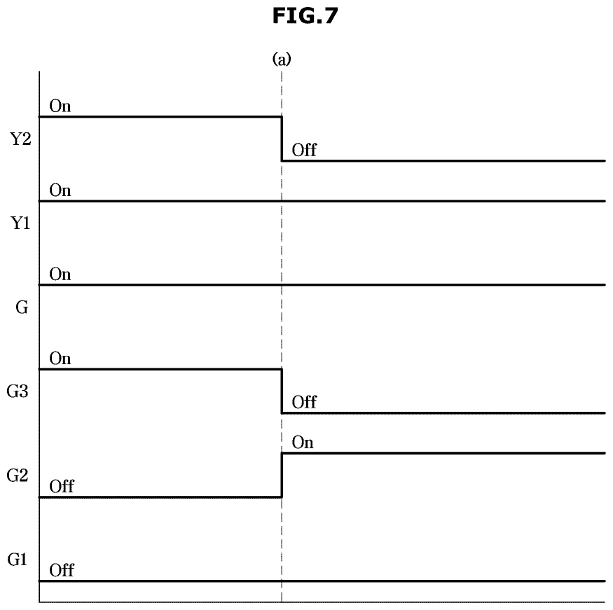

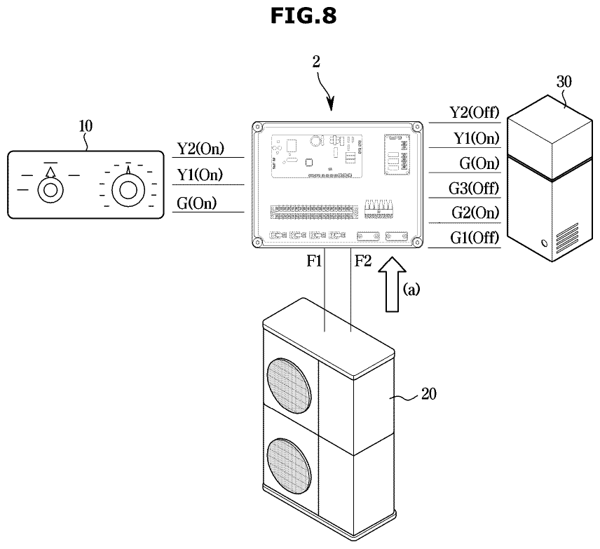

FIG. 7 is a timing diagram illustrating an example process in which an air volume is controlled at light wind by a main controller according to various embodiments. FIG. 8 is a diagram illustrating an example process in which a light wind signal is output from an outdoor unit in an air conditioner according to various embodiments.

Referring to FIG. 7 and FIG. 8, in addition to the indoor fan terminal G, the main controller 2 of the air conditioner 1 according to an embodiment may be provided with additional terminals including a strong wind terminal G3, a light wind terminal G2, and a gentle wind terminal G1 for controlling the air volume. Accordingly, although the air volume control could not be performed in existing contact communication type air conditioners, the air volume control may be performed in the contact communication type air conditioner 1 according to the disclosure.

FIG. 7 and FIG. 8 illustrate an example in which the air volume is controlled from a strong wind to a light wind during a cooling process of the air conditioner 1, but in a heating process, the first compressor terminal Y1 and the second compressor terminal Y2 may be replaced by the first auxiliary heat source terminal W1 and the second auxiliary heat source terminal W2 to operate the same.

Referring to FIG. 7, the controller 110 may set a cooling strong wind in an initial stage of cooling, and control the signals of the first compressor terminal Y1, the second compressor terminal Y2, the indoor fan terminal G, and the strong wind terminal G3 to an ON state to perform cooling at maximum operating capacity.

As shown in FIG. 8, the outdoor unit 20 may output a light wind signal (a). The outdoor unit 20 may transmit the light wind signal (a) to the main controller 2 after a predetermined time has elapsed since a strong wind has been operated, or based on a load on the outdoor unit 20.

Based on the light wind signal (a) from the outdoor unit 20, the main controller 2 may determine an air volume control terminal that outputs an indoor fan control signal from among the plurality of air volume control terminals provided in the main controller 2 by combining the number of times the indoor controller 10 outputs an OFF signal and an off signal output time.

For example, in a case where an OFF signal of the outdoor unit 20 and the indoor unit 30 is received at least three times, which is a predetermined reference number of times, from the indoor controller 10 within a strong wind setting time, the main controller 2 may determine that a cooling capacity is sufficient and may change the air volume to a light wind. In other words, the main controller 2 may control the signal of the light wind terminal G2 to an ON state to change the air volume of the indoor unit 30 to a light wind. In addition, the main controller 2 may control the signal of the second compressor terminal Y2 and the strong wind terminal G3 to an OFF state to allow the indoor unit 30 to be operated in a light wind.

Through the above, the air conditioner 1 according to an embodiment may vary the air volume from strong wind to light wind without stopping, thereby increasing efficiency.

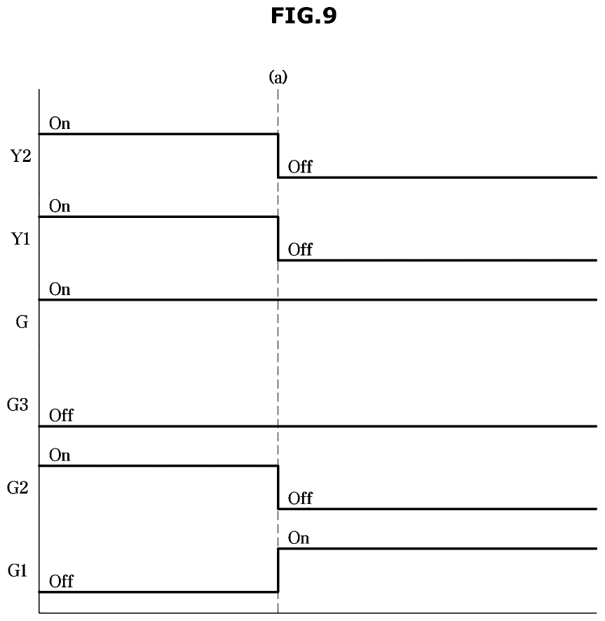

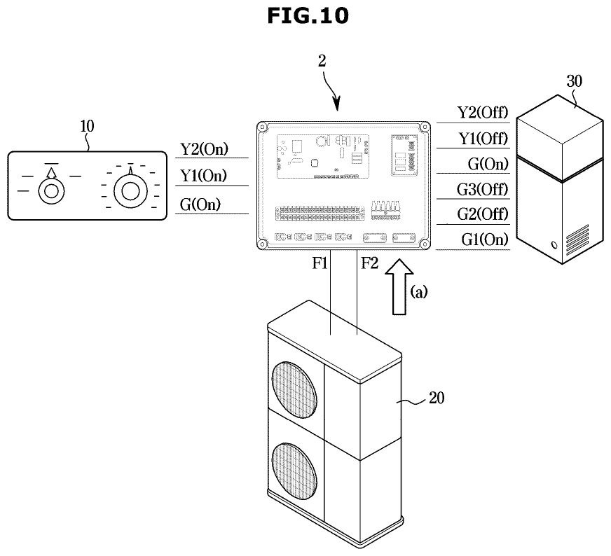

FIG. 9 is a timing diagram illustrating an example process in which an air volume is controlled at gentle wind by a main controller according to various embodiments. FIG. 10 is a diagram illustrating an example process in which a gentle wind signal is output from an outdoor unit in an air conditioner according to various embodiments.

As described above, FIG. 9 and FIG. 10 illustrate an embodiment in which an air volume is controlled from a light wind to a gentle wind during a cooling process of the air conditioner 1, but in a heating process, the first compressor terminal Y1 and the second compressor terminal Y2 may be replaced by the first auxiliary heat source terminal W1 and the second auxiliary heat source terminal W2 to operate the same.

Referring to FIG. 9, the controller 110 may set from cooling strong wind to cooling light wind, and control the signals of the first compressor terminal Y1, the second compressor terminal Y2, the indoor fan terminal G, and the light wind terminal G2 to an ON state to perform cooling in light wind.

As shown in FIG. 10, the outdoor unit 20 may output a gentle wind signal (a). The outdoor unit 20 may transmit the gentle wind signal (a) to the main controller 2 after a predetermined time has elapsed since a light wind has been operated, or based on a load on the outdoor unit 20.

Based on the gentle wind signal (a) from the outdoor unit 20, the main controller 2 may determine an air volume control terminal that outputs an indoor fan control signal from among the plurality of air volume control terminals provided in the main controller 2 by combining the number of times the indoor controller 10 outputs an OFF signal and an off signal output time.

For example, in a case where an OFF signal of the outdoor unit 20 and the indoor unit 30 is received at least two times, which is a predetermined reference number of times, from the indoor controller 10 within a light wind setting time, the main controller 2 may determine that a cooling capacity is sufficient and may change the air volume to a gentle wind. In other words, the main controller 2 may control the signal of the gentle wind terminal G1 to an ON state to change the air volume of the indoor unit 30 to a gentle wind. In addition, the main controller 2 may control the signal of the second compressor terminal Y2, the first compressor terminal Y1, and the light wind terminal G2 to an OFF state to allow the indoor unit 30 to be operated in a gentle wind.

Through the above, the air conditioner 1 according to an embodiment may vary the air volume from light wind to gentle wind without stopping, thereby increasing efficiency.

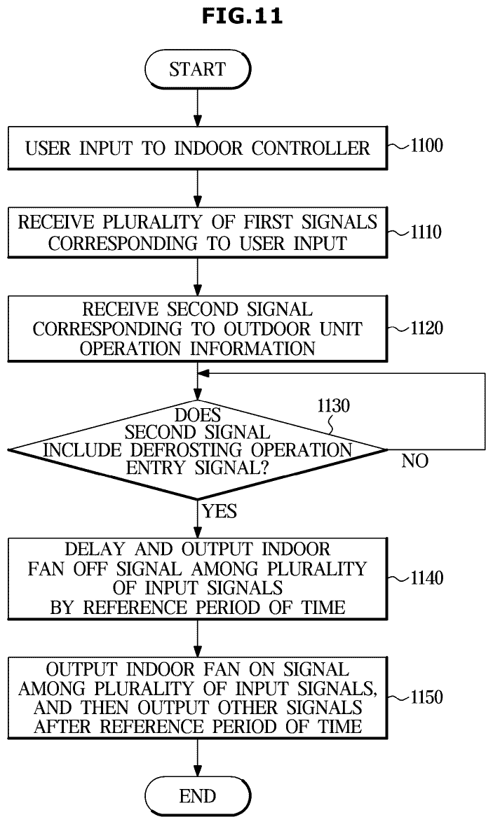

FIG. 11 is a flowchart illustrating example operations where a second signal includes a defrosting operation entry signal, in an air conditioner according to various embodiments.

Referring to FIG. 11, a user may input a user command corresponding to an operation command to the indoor controller 10 (1100). The indoor controller 10 may generate a plurality of first signals corresponding to the user input, and the main controller 2 may receive the plurality of first signals (1110).

In addition, the main controller 2 may receive a second signal corresponding to outdoor unit operation information from the outdoor unit (1120). In this instance, the controller 110 may control the outdoor unit 20 and the indoor unit 30 differently depending on the type of the second signal, and thus the controller 110 may determine whether the second signal includes a defrosting operation entry signal (1130).

Based on determining that the second signal includes the defrosting operation entry signal (Yes in operation 1130), the controller 110 may delay and output an indoor fan off signal among the plurality of input signals by a reference period of time (1140). Accordingly, a residual heat in the air conditioner 1 during heating operation may be removed.

Thereafter, to prevent and/or reduce overheating of heating elements such as a heat exchanger, heater, and the like in the air conditioner 1 due to the defrosting operation, the controller 110 may output only an ON signal of the indoor fan among the plurality of input signals at the completion of the defrosting operation, and may delay and output other ON signals by the reference period of time (1150).

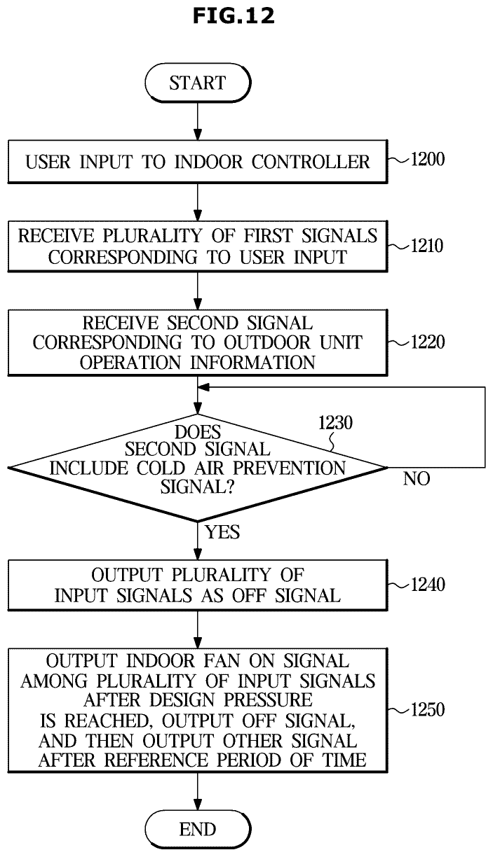

FIG. 12 is a flowchart illustrating example operations where a second signal includes a cold air prevention signal, in an air conditioner according to various embodiments.

Referring to FIG. 12, a user may input a user command corresponding to an operation command to the indoor controller 10 (1200). The indoor controller 10 may generate a plurality of first signals corresponding to the user input, and the main controller may receive the plurality of first signals (1210).

In addition, the main controller 2 may receive a second signal corresponding to outdoor unit operation information from the outdoor unit (1220). In this instance, the controller 110 may control the outdoor unit 20 and the indoor unit 30 differently depending on the type of the second signal, and thus the controller 110 may determine whether the second signal includes a cold air prevention signal (1230).

Based on determining that the second signal includes the cold air prevention signal (Yes in operation 1230), the controller 110 may output the plurality of input signals as an OFF signal (1240) to allow the plurality of input signals to be off until the cold air prevention signal is completed.

The controller 110 may output an ON signal of the indoor fan among the plurality of input signals after a design pressure is reached, and may output the OFF signals of the plurality of input signals, and may output ON signal of other signal after a reference period of time (1250). Accordingly, cold air may be prevented/restricted from entering an indoor space while a heating operation operates or is restarted.

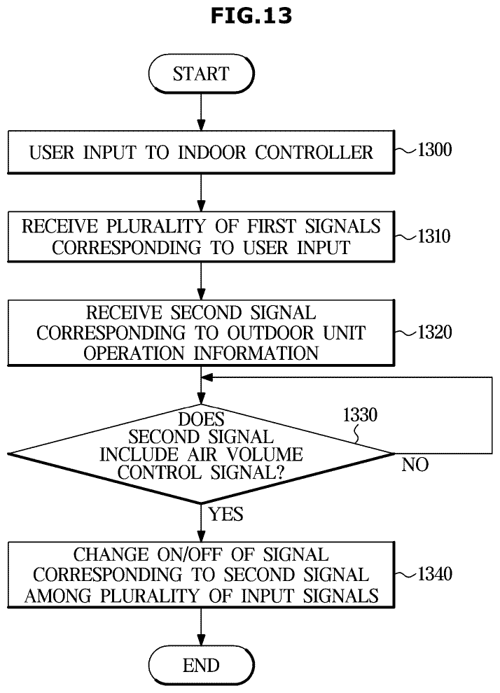

FIG. 13 is a flowchart illustrating example operations where a second signal includes an air volume control signal, in an air conditioner according to various embodiments.

Referring to FIG. 13, a user may input a user command corresponding to an operation command to the indoor controller 10 (1300). The indoor controller 10 may generate a plurality of first signals corresponding to the user input, and the main controller may receive the plurality of first signals (1310).

In addition, the main controller 2 may receive a second signal corresponding to outdoor unit operation information from the outdoor unit (1320). In this instance, the controller 110 may control the outdoor unit 20 and the indoor unit 30 differently depending on the type of the second signal, and thus the controller 110 may determine whether the second signal includes an air volume control signal (1330).

Based on determining that the second signal includes the air volume control signal (Yes in operation 1230), the controller 110 may change the on/off of a signal corresponding to the second signal among the plurality of input signals (1340).

For example, in a case where the indoor unit 30 currently operates at strong wind, an ON signal of the strong wind terminal G3 may be changed to an OFF signal based on a light wind signal of the outdoor unit 20, and an OFF signal of the light wind terminal G2 may be changed to an ON signal. Similarly, in a case where the indoor unit 30 operates at light wind, an ON signal of the light wind terminal G2 may be changed to an OFF signal based on a gentle wind signal of the outdoor unit 20 and an OFF signal of the light wind terminal G2 may be changed to an ON signal.

As will be apparent from the above, the air conditioner 1 according to an embodiment may convert a plurality of first signals into a single second signal to enable connection between an inverter outdoor unit 20 and an existing fixed speed air conditioner through the main controller 2, thereby satisfying both compatibility of a fixed speed product and efficiency of an inverter product. Also, indoor fans, auxiliary heat sources, and other air conditioning devices may be controlled based on a state of the outdoor unit, thereby increasing user convenience.

According to an embodiment of the disclosure, an air conditioner may include: an indoor controller configured to receive an operation command from a user and generate a plurality of first signals corresponding to the operation command; a main controller configured to receive the plurality of first signals by being connected to the indoor controller, and combine the plurality of first signals to convert the combined first signals into a single second signal; an outdoor unit configured to operate based on the single second signal received from the main controller by being connected to the main controller, and generate a third signal corresponding to an operation state of the outdoor unit; and an indoor unit connected to the main controller and equipped with an indoor fan, wherein the main controller may be configured to control the indoor fan based on the plurality of first signals and the third signal.

The third signal may include one of an air volume control signal, a defrosting operation signal, or a cold air protection signal.

The main controller may be configured to determine an air volume control terminal that outputs an indoor fan control signal from among a plurality of air volume control terminals provided in the main controller by combining a number of times an OFF signal is output and an off signal output time of the indoor controller, based on the third signal being an air volume control signal.

The main controller may be configured to determine the air volume control terminal to reduce an air volume of the indoor unit based on the number of times the OFF signal is output being greater than or equal to a reference number of times, and the off signal output time being greater than or equal to a reference period of time.

The main controller may be configured to delay and output an OFF signal of the indoor fan for a reference period of time, based on the third signal being a defrosting operation signal.

The main controller may be configured to output an ON signal of the indoor fan from among a plurality of signals at a time when a defrosting operation termination signal for ending a defrosting operation is received from the outdoor unit, and output other signals after a predetermined time.

Based on the third signal being a cold air prevention signal, the main controller may be configured to delay an output of the plurality of signals until a cold air prevention termination signal is received.

The main controller may be configured to delay an output of the plurality of signals until a pressure of a compressor is greater than or equal to a reference pressure, based on receiving a signal to restart a heating operation from the outdoor unit.

According to an embodiment of the disclosure, a method for controlling an air conditioner may include: receiving, by an indoor controller, an operation command from a user and generating a plurality of first signals corresponding to the operation command; receiving, by a main controller, the plurality of first signals by being connected to the indoor controller, and combining the plurality of first signals to convert the combined first signals into a single second signal; operating, by an outdoor unit, based on the single second signal received from the main controller by being connected to the main controller, and generating a third signal corresponding to an operation state of the outdoor unit; and controlling an indoor fan based on the plurality of first signals and the third signal.

The third signal may include one of an air volume control signal, a defrosting operation signal, or a cold air protection signal.

The method may further include: determining an air volume control terminal that outputs an indoor fan control signal from among a plurality of air volume control terminals provided in the main controller by combining a number of times an OFF signal is output and an off signal output time of the indoor controller, based on the third signal being an air volume control signal.

The determining of the air volume control terminal may include determining the air volume control terminal to reduce an air volume of the indoor unit, based on the number of times the OFF signal is output being greater than or equal to a reference number of times, and the off signal output time being greater than or equal to a reference period of time.

The method may further include delaying and outputting an OFF signal of the indoor fan for a reference period of time, based on the third signal being a defrosting operation signal.

The method may further include outputting an ON signal of the indoor fan the reference period of time earlier than at a time when a defrosting operation termination signal for ending a defrosting operation is received from the outdoor unit.

The method may further include delaying and outputting an OFF signal of the indoor fan for a reference period of time, based on the third signal being a cold air prevention signal.

The delaying and outputting of the OFF signal of the indoor fan may further include: delaying and outputting the ON signal of the indoor fan until a pressure of a compressor is greater than or equal to a reference pressure, based on receiving a signal to restart a heating operation from the outdoor unit.

The disclosed example embodiments may be implemented in the form of a recording medium that stores instructions executable by a computer. The instructions may be stored in the form of program codes, and when executed by a processor, the instructions may create a program module to perform operations of the disclosed embodiments.

The machine-readable recording medium may be provided in the form of a non-transitory storage medium, wherein the ‘non-transitory storage medium’ is a tangible device, and may not include a signal (e.g., an electromagnetic wave), but this term does not differentiate between where data is semi-permanently stored in the storage medium and where the data is temporarily stored in the storage medium. For example, a ‘non-transitory storage medium’ may include a buffer in which data is temporarily stored.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloadable or uploadable) online via an application store (e.g., Play Store™) or between two user devices (e.g., smartphones) directly. When distributed online, at least part of the computer program product (e.g., a downloadable app) may be temporarily generated or at least temporarily stored in the machine-readable storage medium, such as a memory of the manufacturer's server, a server of the application store, or a relay server.

While the disclosure has been illustrated and described with reference to various example embodiments, it should be understood by those skilled in the art that various changes in form and detail may be made without departing from the spirit and scope of the disclosure.

What is claimed is:

1. An air conditioner, comprising:
an indoor controller, comprising circuitry, configured to receive an operation command and generate a plurality of first signals corresponding to the operation command;
a main controller, comprising circuitry, configured to receive the plurality of first signals from the indoor controller, and combine the plurality of first signals to convert the combined first signals into a single second signal;
an outdoor unit configured to operate based on the single second signal received from the main controller, and generate a third signal corresponding to an operation state of the outdoor unit; and
an indoor unit connected to the main controller and including an indoor fan,
wherein the main controller is configured to control the indoor fan based on the plurality of first signals and the third signal.

2. The air conditioner of claim 1, wherein the third signal includes one of an air volume control signal, a defrosting operation signal, or a cold air protection signal.

3. The air conditioner of claim 1, wherein the main controller is configured to determine an air volume control terminal configured to output an indoor fan control signal from among a plurality of air volume control terminals provided in the main controller by combining a number of times an OFF signal is output and an off signal output time of the indoor controller, based on the third signal being an air volume control signal.

4. The air conditioner of claim 3, wherein the main controller is configured to determine the air volume control terminal to reduce an air volume of the indoor unit based on the number of times the OFF signal is output being greater than or equal to a reference number of times, and the off signal output time being greater than or equal to a reference period of time.

5. The air conditioner of claim 1, wherein the main controller is configured to delay and output an OFF signal of the indoor fan for a reference period of time, based on the third signal including a defrosting operation signal.

6. The air conditioner of claim 5, wherein the main controller is configured to output an ON signal of the indoor fan from among a plurality of signals at a time at which a defrosting operation termination signal for ending a defrosting operation is received from the outdoor unit, and output other signals after a specified time.

7. The air conditioner of claim 1, wherein the main controller is configured to delay and output an OFF signal of the indoor fan for a reference period of time, based on the third signal including a cold air prevention signal.

8. The air conditioner of claim 7, wherein the main controller is configured to delay and output the ON signal of the indoor fan until a pressure of a compressor is greater than or equal to a reference pressure, based on receiving a signal to restart a heating operation from the outdoor unit.

9. A method for controlling an air conditioner, the method comprising:
receiving, by an indoor controller, an operation command and generating a plurality of first signals corresponding to the operation command;
receiving, by a main controller, the plurality of first signals from the indoor controller, and combining the plurality of first signals to convert the combined first signals into a single second signal;
operating, by an outdoor unit, based on the single second signal received from the main controller, and generating a third signal corresponding to an operation state of the outdoor unit; and
controlling an indoor fan based on the plurality of first signals and the third signal.

10. The method of claim 9, wherein the third signal includes one of an air volume control signal, a defrosting operation signal, or a cold air protection signal.

11. The method of claim 9, further comprising:
determining an air volume control terminal configured to output an indoor fan control signal from among a plurality of air volume control terminals provided in the main controller by combining a number of times an OFF signal is output and an off signal output time of the indoor controller, based on the third signal being an air volume control signal.

12. The method of claim 11, wherein the determining of the air volume control terminal may include determining the air volume control terminal to reduce an air volume of the indoor unit, based on the number of times the OFF signal is output being greater than or equal to a reference number of times, and the off signal output time being greater than or equal to a reference period of time.

13. The method of claim 11, further comprising:
delaying and outputting an OFF signal of the indoor fan for a reference period of time, based on the third signal including a defrosting operation signal.

14. The method of claim 13, further comprising:
outputting an ON signal of the indoor fan from among a plurality of signals at a time at which a defrosting operation termination signal for ending a defrosting operation is received from the outdoor unit, and outputting other signals after a specified time.

15. The method of claim 9, further comprising:
delaying and outputting an OFF signal of the indoor fan for a reference period of time, based on the third signal including a cold air prevention signal.
